(19) United States
(12) Patent Application Publication
(10) Pub. No.: US 2011/0163609 A1
(43) Pub. Date: Jul. 7, 2011

(54) WIRELESS POWER FEED SYSTEM

(75) Inventors: Hirotsugu Wada, Kanagawa (JP); Takashi Miyamoto, Chiba (JP)

(73) Assignee: SONY CORPORATION, Tokyo (JP)

(21) Appl. No.: 12/977,190

(22) Filed: Dec. 23, 2010

(30) Foreign Application Priority Data
Jan. 7, 2010 (JP) 2010-002187

(51) Int. Cl. H01F 38/14

(52) U.S. Cl. 307/104

(57) ABSTRACT

Disclosed herein is a wireless power feed system including a power feed device, and a power receiving device configured to receive power transmitted from the power feed device. The power feed device includes a power generator to generate power that should be fed, and a resonant element fed with power generated by the power generator. The power receiving device includes a power receiving element to receive power transmitted from the power feed device, and a matching unit including a function for impedance matching at a connecting part between the power and a load of the power receiving element.

### BACKGROUND OF THE INVENTION

1. Field of the Invention

The present invention relates to a wireless power feed system based on a non-contact power feed system for non-contact (wireless) supply and reception of power.

2. Description of the Related Art

An electromagnetic induction system is known as a system for wireless supply of power.

Furthermore, in recent years, wireless power feed and charge systems employing a system called the magnetic field resonance system based on an electromagnetic resonance phenomenon are attracting attention.

Presently, in the non-contact power feed system based on the electromagnetic induction system, which has been already widely used, the power feed source and the power feed target (power receiving side) need to share magnetic flux. Therefore, the power feed source and the power feed target need to be disposed extremely close to each other for power sending with high efficiency, and axis alignment of the coupling is also important.

In contrast, the non-contact power feed system employing the electromagnetic resonance phenomenon has advantages that power can be transmitted across a longer distance compared with the electromagnetic induction system and the transmission efficiency is not greatly lowered even when the accuracy of axis alignment is somewhat low, because of the principle of the electromagnetic resonance phenomenon.

Besides the magnetic field resonance system, the electric field resonance system is also known as the system based on the electromagnetic resonance phenomenon.

For example, Japanese Patent Laid-Open No. 2001-185939 (referred to as Patent Document 1 hereinafter) discloses a wireless power feed system employing the magnetic field resonance system.

The technique disclosed in Patent Document 1 has a configuration in which power is transmitted from a power feed coil connected to a power feed circuit to a resonant coil (referred to also as a resonance coil) by electromagnetic induction, and the frequency is adjusted by a capacitor and a resistor connected to the resonant coil.

In recent years, a report has been made on a wireless power transmission technique in which the magnetic field resonance system based on the resonant phenomenon of a magnetic field is employed and transmission of power of 60 W across a distance of 2 m is realized.

Furthermore, a report has been made on development of a “wireless power feed system” of high efficiency in which the magnetic field resonance system is employed and power of 60 W is transmitted to drive an electronic apparatus at a distance of 50 cm.

By this wireless power transmission technique, wireless transmission of power of several tens of watts can be performed across a distance of several meters. Thus, this technique is expected to be applied to commercial products of new concepts in offices and homes.

### SUMMARY OF THE INVENTION

However, the wireless power feed system of the magnetic field resonance type has a problem that, when the power transmission/reception distance is shortened, the frequency characteristic changes and the transmission efficiency is lowered on the contrary.

As the method to solve this problem, e.g. the following methods exist.

Specifically, in response to change in the frequency characteristic,

1) the power supply frequency itself is varied for adjustment,

2) the inductance and capacitance of the coil on the power transmitting side are adjusted to cancel the change, and

3) a circuit to adjust the impedance is inserted in the power supply circuit on the power transmitting side.

However, in all methods, any device to detect the change in the frequency characteristic and make adjustment is required, which precludes simplification and size reduction of the system.

In the wireless power feed system of the magnetic field resonance type, a coil having a high quality factor and a large size is necessary in both of the power transmitting side and the power receiving side. This precludes size reduction of wireless apparatus of the power receiving side particularly.

In the wireless power feed system of the electromagnetic induction type, a coil having a large number of winding turns, a ferrite core, and so forth are used in order to enhance magnetic flux. This increases the weight and precludes size reduction.

There is a desire for the present invention to provide a wireless power feed system that can prevent the lowering of the transmission efficiency and achieve simplification and size reduction of the system.

According to a first embodiment of the present invention, there is provided a wireless power feed system including a power feed device, and a power receiving device configured to receive power transmitted from the power feed device. The power feed device includes a power generator to generate power that should be fed, and a resonant element fed with power generated by the power generator. The power receiving device includes a power receiving element to receive power transmitted from the power feed device, and a matching unit including a function for impedance matching at a connecting part between the power and a load of the power receiving element.

The embodiment of the present invention can prevent the lowering of the transmission efficiency and achieve simplification and size reduction of the system.

### BRIEF DESCRIPTION OF THE DRAWINGS

FIG. 1 is a block diagram showing a configuration example of a wireless power feed system according to an embodiment of the present invention;

FIG. 2 is a diagram schematically showing the relationship between a coil on the power transmitting side and a coil on the power receiving side in the wireless power feed system according to the embodiment;

FIG. 3 is a Smith chart showing the impedance characteristic of a power receiving coil to which a matching circuit according to the embodiment is connected;

FIG. 4 is a Smith chart showing the impedance characteristic of a power receiving coil having no matching circuit as a comparative example;

FIG. 5 is a characteristic diagram showing the transmission loss characteristic of the wireless power feed system according to the embodiment;

FIG. 6 is a diagram showing the relationship among the transmission distance, the transmission loss, and the frequency of the wireless power feed system according to the embodiment in association with each other;

FIG. 7 is a diagram schematically showing power transmitting and receiving coils in the wireless power feed system according to the embodiment;

FIG. 8 is a characteristic diagram showing the transmission loss characteristic of a wireless power feed system of the resonance type as a comparative example;

FIG. 9 is a diagram showing the relationship among the transmission distance, the transmission loss, and the frequency of the wireless power feed system of the resonance type in association with each other as the comparative example;

FIG. 10 is a diagram schematically showing power transmitting and receiving coils in the wireless power feed system of the resonance type as the comparative example;

FIG. 11 is a characteristic diagram showing the transmission loss characteristic of a wireless power feed system of the electromagnetic induction type as a comparative example;

FIG. 12 is a diagram showing the relationship among the transmission distance, the transmission loss, and the frequency of the wireless power feed system of the electromagnetic induction type in association with each other as the comparative example;

FIG. 13 is a diagram schematically showing power transmitting and receiving coils in the wireless power feed system of the electromagnetic induction type as the comparative example;

FIG. 14 is a block diagram showing a configuration example of a wireless power feed system according to a second embodiment of the present invention;

FIG. 15 is a block diagram showing a configuration example of a wireless power feed system according to a third embodiment of the present invention; and

FIG. 16 is a diagram showing an application example of the wireless power feed system according to an embodiment of the present invention.

### DETAILED DESCRIPTION OF THE PREFERRED EMBODIMENTS

Embodiments of the present invention will be described below in association with the drawings.

The order of the description is as follows.

1. First Embodiment (first configuration example of wireless power feed system)
2. Second Embodiment (second configuration example of wireless power feed system)
3. Third Embodiment (third configuration example of wireless power feed system)
4. Fourth Embodiment (application of wireless power feed system)

### 1. First Embodiment

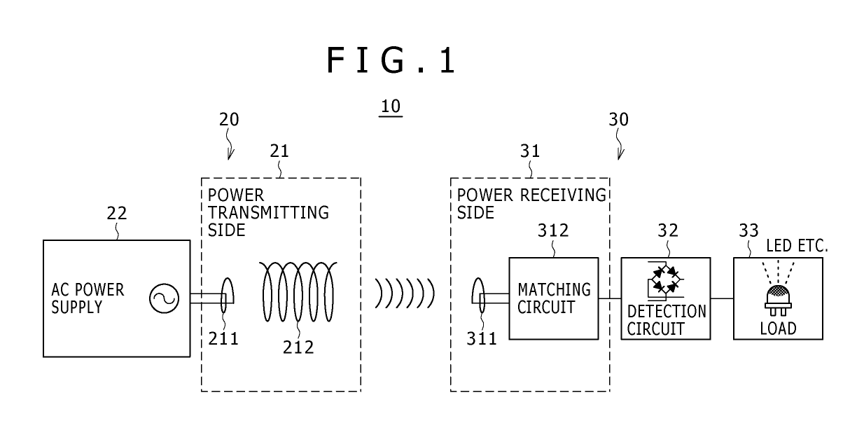

FIG. 1 is a block diagram showing a configuration example of a wireless power feed system according to a first embodiment of the present invention.

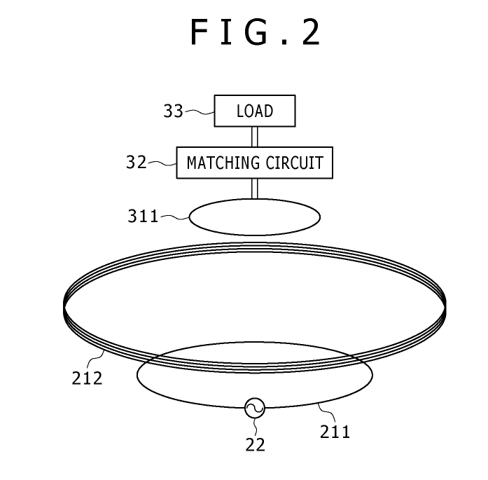

FIG. 2 is a diagram schematically showing the relationship between the coil on the power transmitting side and the coil on the power receiving side in the wireless power feed system according to the first embodiment.

This wireless power feed system 10 is formed as a power transmission system.

This wireless power feed system 10 has a power feed device 20 and a power receiving device 30.

The power feed device 20 includes a power transmitting coil unit 21 and a high-frequency power generator 22.

The power transmitting coil unit 21 has a power feed coil 211 as the power feed element and a resonant coil 212 as the resonant element.

Although the resonant coil is referred to also as the resonance coil, the term “the resonant coil” will be used in the description of the present embodiment.

The power feed coil 211 is formed by a loop coil fed with an alternating current (AC) current.

The resonant coil 212 is formed by an air core coil coupled to the power feed coil 211 by electromagnetic induction, and wirelessly transmits the AC power fed by the power feed coil 211 with high efficiency.

On the power feed side, the power feed coil 211 and the resonant coil 212 are strongly coupled to each other by electromagnetic induction.

The high-frequency power generator 22 generates high-frequency power (AC power) for wireless power transmission.

The high-frequency power generated by the high-frequency power generator 22 is fed (applied) to the power feed coil 211 of the power transmitting coil unit 21.

The power receiving device 30 includes a power receiving coil unit 31, a detection circuit 32, and a load 33, such as a light emitting diode (LED), as the supply target of the received power.

The power receiving coil unit 31 has a power receiving coil 311 and a matching circuit 312 as the matching unit.

The power receiving coil 311 has a coupling relationship with the resonant coil 212 on the side of the power feed device 20 and receives the AC power transmitted from the power feed device 20.

The matching circuit 312 has a function for impedance matching at the load end of the power receiving coil 311 in accordance with a control signal supplied by a controller (not shown).

The detection (rectification) circuit 32 rectifies the received AC power to turn it to direct current (DC) power. Subsequently, in a voltage regulation circuit (not shown), the supplied DC power is converted to DC voltage suitable for the specifications of the electronic apparatus as the supply target, and the regulated DC voltage is supplied to the load 33 such as an LED.

The configuration example of the power transmitting and receiving coils will be described below in association with FIG. 2.

In this wireless power feed system 10, the resonant coil is only one coil, i.e. the resonant coil 212 on the power transmitting side.

The power feed coil 211 and the resonant coil 212 on the power transmitting side are coupled to each other by electromagnetic induction.

Furthermore, the resonant coil 212 and the power receiving coil 311 on the power receiving side are coupled to each other to supply power to the load 33.

Integrating the power feed coil 211 and the resonant coil 212 on the power transmitting side as a power transmitting (power feed) device makes it possible to employ a configuration in which only the power receiving coil 311 and the matching circuit 312 are included in the power receiving side, and thus allows size reduction and simplification of the power receiving device 30.

The outline of the overall operation of this wireless power feed system 10 will be described below.

The AC power generated by the high-frequency power generator 22 is fed to the power feed coil 211 and then transmitted via the power feed coil 211 to the resonant coil 212 for power transmission by coupling based on electromagnetic induction.

The power supplied to the resonant coil 212 for power transmission is supplied to the detection circuit 32 via the power receiving coil 311 connected to the matching circuit 312 at the frequency determined by the resonant coil 212.

The AC power is converted to DC power by the detection circuit 32. Thereafter, in the voltage regulation circuit (not shown), the DC power is converted to DC voltage suitable for the specifications of the electronic apparatus as the supply target, and the regulated DC voltage is supplied to the load 33 such as an LED.

It will also be possible to change the frequency determined by the resonant coil 212 on the power transmitting side depending on the system used. However, the power receiving coil 311 in this system 10 does not resonate.

Therefore, by adjustment of the coupling strength varying depending on the distance between the resonant coil 212 on the power transmitting side and the power receiving coil 311 and impedance adjustment by the matching circuit 312, the power receiving side can be used even with the combination with the power transmitting coil of a different resonant frequency.

That is, in the wireless power feed system 10 of the present embodiment, the frequency is determined by the resonant coil 212 for power transmission.

Furthermore, the transmission characteristic can be adjusted by adjustment of the coupling strength varying depending on the distance D between the resonant coil 212 on the power transmitting side and the power receiving coil 311 and impedance adjustment by the matching circuit 312 on the power receiving side.

A consideration will be made below about the impedance characteristic of the power receiving coil.

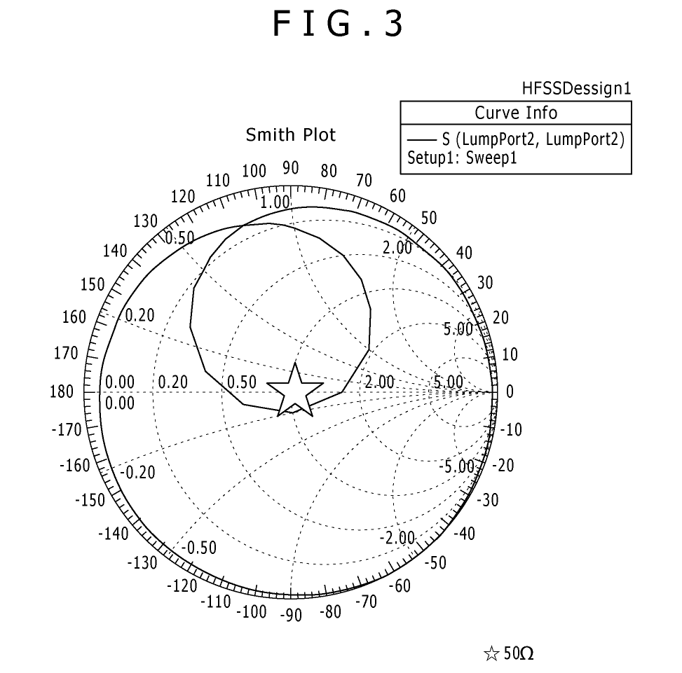

FIG. 3 is a Smith chart showing the impedance characteristic of the power receiving coil to which the matching circuit according to the present embodiment is connected.

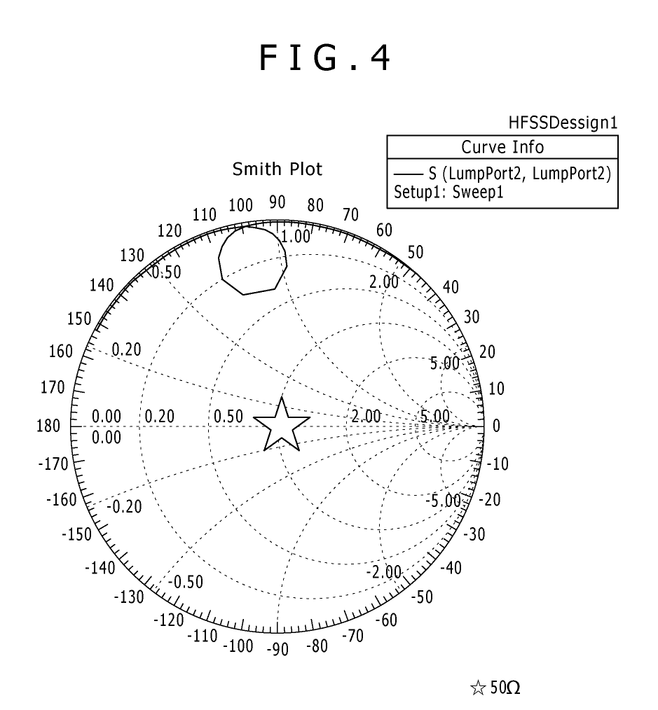

FIG. 4 is a Smith chart showing the impedance characteristic of a power receiving coil having no matching circuit as a comparative example.

Because the power receiving coil 311 has a small structure with a small number of winding turns, the values of the inductance and capacitance thereof are small and the impedance thereof is low.

Therefore, if the power receiving coil 311 does not have the matching circuit like in the comparative example, the impedance does not match with respect to the load 33 on the power receiving side and the transmission loss is large. Consequently, as shown in FIG. 4, use with high efficiency is impossible if this configuration is employed as it is.

In contrast, by adding the matching circuit 312 between the power receiving coil 311 and the load 33 like in the present embodiment, matching of the impedance with respect to the load can be achieved and the transmission efficiency can be enhanced as shown in FIG. 3.

Next, the transmission loss characteristic of the wireless power feed system according to the present embodiment will be considered.

As comparative examples, the transmission loss characteristics of a wireless power feed system of the magnetic field resonance type and a wireless power feed system of the electromagnetic induction type will also be shown.

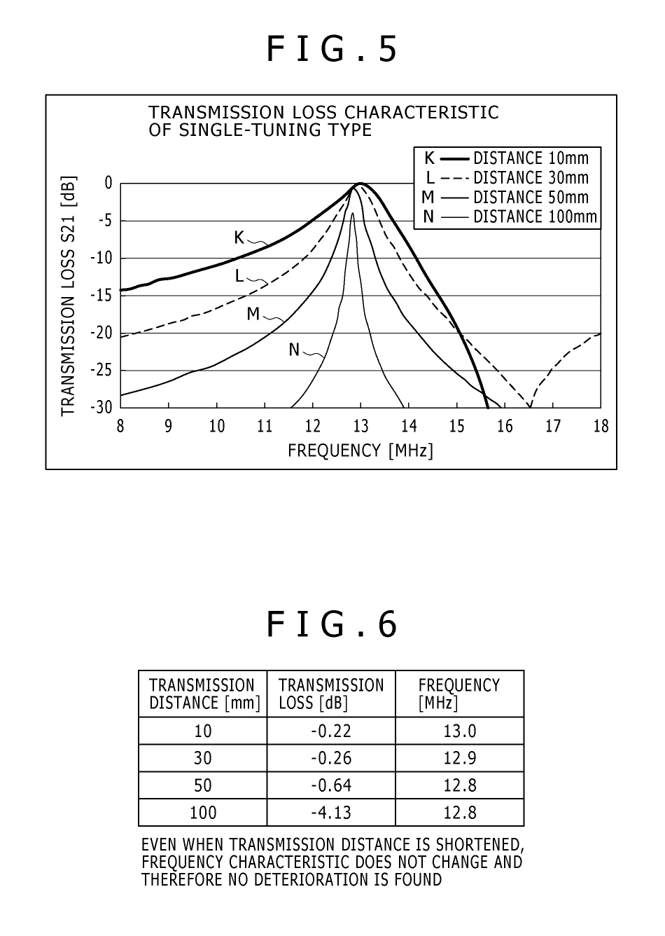

FIG. 5 is a characteristic diagram showing the transmission loss characteristic of the wireless power feed system according to the present embodiment.

FIG. 6 is a diagram showing the relationship among the transmission distance, the transmission loss, and the frequency of the wireless power feed system according to the present embodiment in association with each other.

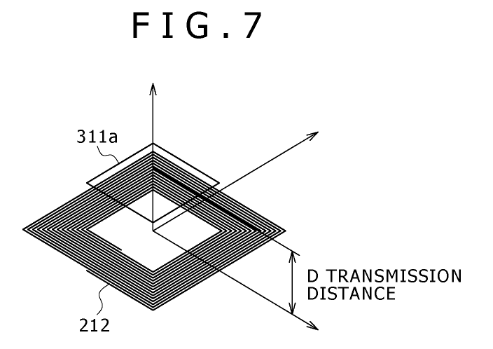

FIG. 7 is a diagram schematically showing the power transmitting and receiving coils in the wireless power feed system according to the present embodiment.

In FIG. 7, the correspondence relationship between the resonant coil 212 and a power receiving loop coil 311a is shown.

In this example, the resonant coil 212 is formed into a rectangular shape in which the number of winding turns is 14 and the length of one side is 170 mm.

The power receiving loop coil 311a is formed into a rectangular shape in which the number of winding turns is 1 and the length of one side is 90 mm.

In both coils, the wire diameter of the coil is 1 mm.

The distance between the resonant coil 212 and the power receiving coil 311a is the transmission distance D.

In FIG. 5, the abscissa indicates the frequency and the ordinate indicates the transmission loss.

In FIG. 5, the curve indicated by K shows the transmission loss characteristic when the transmission distance D is 10 mm, and the curve indicated by L shows the transmission loss characteristic when the transmission distance D is 30 mm.

In FIG. 5, the curve indicated by M shows the transmission characteristic when the transmission distance D is 50 mm, and the curve indicated by N shows the transmission characteristic when the transmission distance D is 100 mm.

In the wireless power feed system 10 according to the present embodiment, as shown in FIG. 5 and FIG. 6, when the transmission distance D is 10 mm, the transmission loss is −0.22 [dB] and the resonant frequency is 13.0 [MHz].

When the transmission distance D is 30 mm, the transmission loss is −0.26 [dB] and the frequency is 12.9 [MHz].

When the transmission distance D is 50 mm, the transmission loss is −0.64 [dB] and the frequency is 12.8 [MHz].

When the transmission distance D is 100 mm, the transmission loss is −4.13 [dB] and the frequency is 12.8 [MHz].

As just described, in the wireless power feed system 10 according to the present embodiment, even when the transmission distance D is shortened, the frequency characteristic of the resonant coil 212 does not change and therefore the transmission characteristic does not deteriorate.

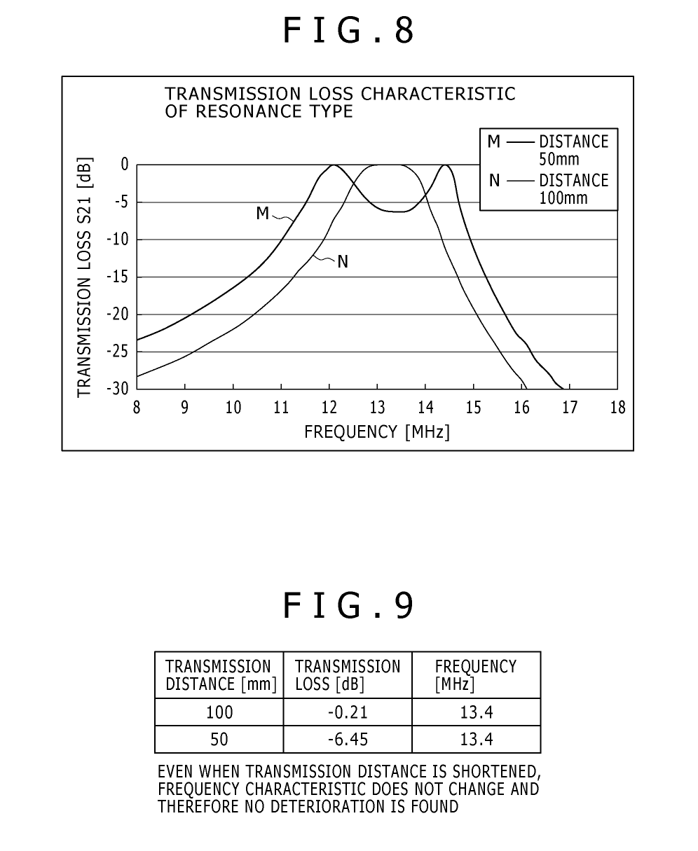

FIG. 8 is a characteristic diagram showing the transmission loss characteristic of the wireless power feed system of the resonance type as the comparative example.

FIG. 9 is a diagram showing the relationship among the transmission distance, the transmission loss, and the frequency of the wireless power feed system of the resonance type in association with each other as the comparative example.

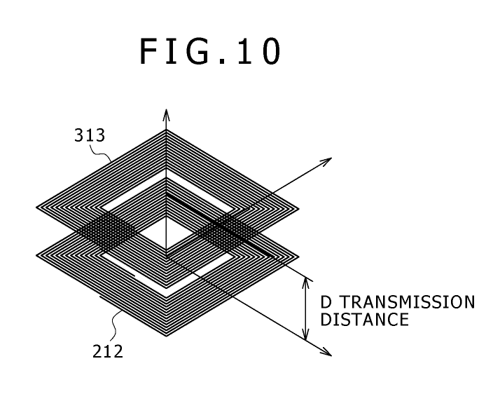

FIG. 10 is a diagram schematically showing the power transmitting and receiving coils of the wireless power feed system of the resonance type as the comparative example.

In FIG. 10, the correspondence relationship between the resonant coil 212 on the power transmitting side and a resonant coil 313 on the power receiving side is shown.

In this example, each of the resonant coil 212 on the power transmitting side and the resonant coil 313 on the power receiving side is formed into a rectangular shape in which the number of winding turns is 14 and the length of one side is 170 mm.

In both coils, the wire diameter of the coil is 1 mm.

The distance between the resonant coil 212 on the power transmitting side and the resonant coil 313 on the power receiving side is the transmission distance D.

In FIG. 8, the abscissa indicates the frequency and the ordinate indicates the transmission loss.

In FIG. 8, the curve indicated by M shows the transmission characteristic when the transmission distance D is 50 mm, and the curve indicated by N shows the transmission characteristic when the transmission distance D is 100 mm.

In the wireless power feed system of the resonance type, as shown in FIG. 8 and FIG. 9, when the transmission distance D is 100 mm, the transmission loss is −0.21 [dB] and the frequency is 13.4 [MHz].

When the transmission distance D is 50 mm, the transmission loss is −6.45 [dB] and the frequency is 13.4 [MHz].

As just described, in the wireless power feed system of the resonance type, when the transmission distance D is shortened, the frequency characteristic changes and the transmission characteristic deteriorates in the use frequency band on the contrary.

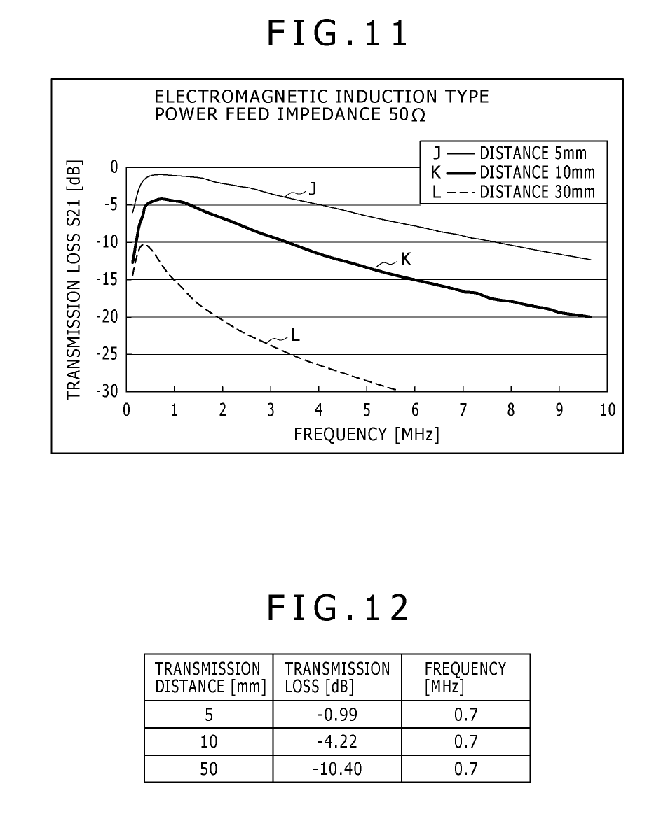

FIG. 11 is a characteristic diagram showing the transmission loss characteristic of the wireless power feed system of the electromagnetic induction type as the comparative example.

FIG. 12 is a diagram showing the relationship among the transmission distance, the transmission loss, and the frequency of the wireless power feed system of the electromagnetic induction type in association with each other as the comparative example.

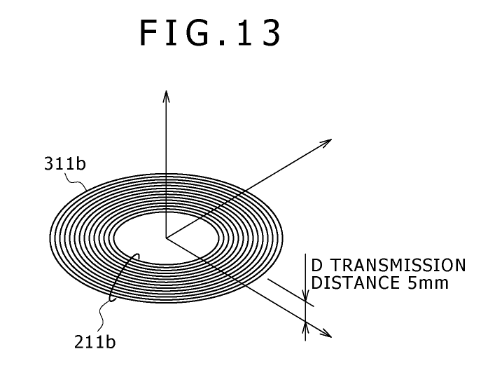

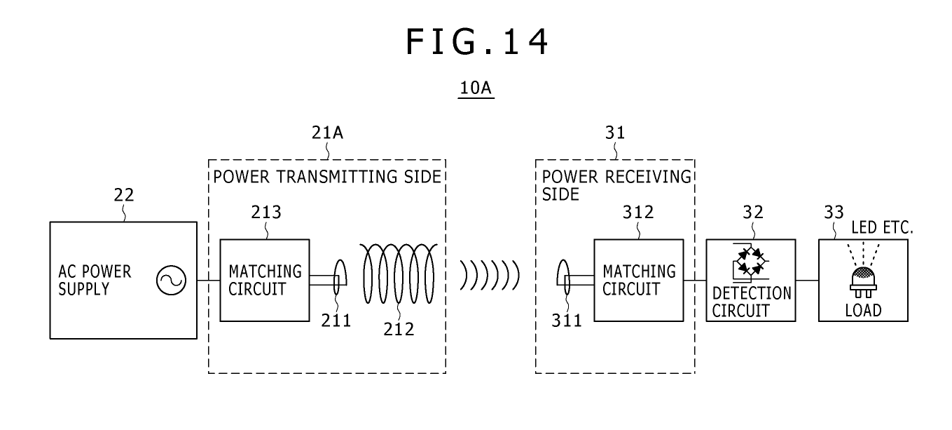

FIG. 13 is a diagram schematically showing the power transmitting and receiving coils of the wireless power feed system of the electromagnetic induction type as the comparative example.

In FIG. 13, the correspondence relationship between a power feed coil (power transmitting coil) 211b on the power transmitting side and a power feed coil (power receiving coil) 311b on the power receiving side is shown.

The distance between the power feed coil 211b on the power transmitting side and the power feed coil 311b on the power receiving side is the transmission distance D.

In FIG. 11, the abscissa indicates the frequency and the ordinate indicates the transmission loss.

In FIG. 11, the curve indicated by J shows the transmission characteristic when the transmission distance D is 5 mm. The curve indicated by K shows the transmission characteristic when the transmission distance D is 10 mm. The curve indicated by L shows the transmission characteristic when the transmission distance D is 50 mm.

In the wireless power feed system of the electromagnetic induction type, as shown in FIG. 11 and FIG. 12, when the transmission distance D is 5 mm, the transmission loss is −0.99 [dB] and the frequency is 0.7 [MHz].

When the transmission distance D is 10 mm, the transmission loss is −4.22 [dB] and the frequency is 0.7 [MHz].

When the transmission distance D is 50 mm, the transmission loss is −10.40 [dB] and the frequency is 0.3 [MHz].

As just described, in the wireless power feed system of the electromagnetic induction type, the transmission characteristic deteriorates when the transmission distance D is increased.

That is, in the wireless power feed system of the electromagnetic induction type, the transmission distance is several millimeters.

In contrast, in the wireless power feed system 10 according to the present embodiment, the transmission distance can be extended compared with the electromagnetic induction type. Thus, the wireless power feed system 10 has high flexibility in placement and is suitable for power feed and charge for small apparatus.

Furthermore, as described above, the wireless power feed system 10 according to the present embodiment is free from the problem that, when the transmission distance is shortened, the frequency characteristic changes and the transmission characteristic deteriorates on the contrary, differently from the resonance type.

That is, in the wireless power feed system 10 according to the present embodiment, even when the transmission distance is shortened, the frequency characteristic of the resonant coil does not change and therefore the transmission characteristic does not deteriorate.

### 2. Second Embodiment

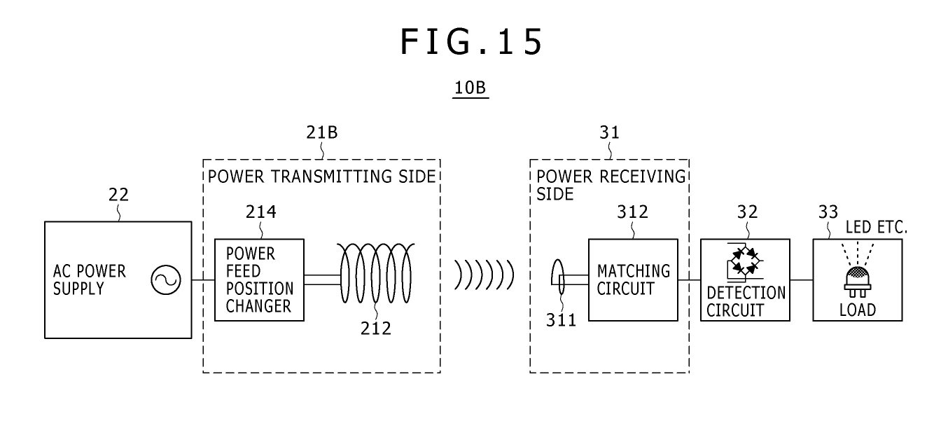

FIG. 14 is a block diagram showing a configuration example of a wireless power feed system according to a second embodiment of the present invention.

A wireless power feed system 10A according to the second embodiment is different from the wireless power feed system 10 according to the first embodiment in that a matching circuit 213 is connected to the power feed coil 211 in a power transmitting coil unit 21A of a power feed device 20A.

In this wireless power feed system 10A, AC power generated by the high-frequency power generator 22 is transmitted to the resonant coil 212 for power transmission by coupling based on electromagnetic induction via the power feed coil 211 connected to the matching circuit 213. In the matching circuit 213, impedance adjustment on the power transmitting side is carried out.

The power supplied to the resonant coil 212 for power transmission is supplied to the detection circuit 32 via the power receiving coil 311 connected to the matching circuit 312 at the resonant frequency.

By connecting the matching circuit 213 to the power feed coil 211 also in the power transmitting coil unit 21A in this manner, impedance adjustment on the power transmitting side is enabled and the transmission efficiency can be enhanced.

### 3. Third Embodiment

FIG. 15 is a block diagram showing a configuration example of a wireless power feed system according to a third embodiment of the present invention.

A wireless power feed system 10B according to the third embodiment is different from the wireless power feed system 10 according to the first embodiment in that a power feed position changer 214 is disposed instead of the power feed coil 211 in a power transmitting coil unit 21B of a power feed device 20B.

The power feed position changer 214 includes e.g. a switch to vary the connecting node between the supply line of AC power and the resonant coil 212. The power feed position changer 214 can vary the position of the power feed to the resonant coil 212, and can adjust the resonant frequency of the resonant coil and the impedance of the resonant coil.

In this wireless power feed system 10B, AC power generated by the high-frequency power generator 22 is transmitted to the resonant coil 212 for power transmission by coupling based on electromagnetic induction via the power feed position changer 214.

The power supplied to the resonant coil 212 for power transmission is supplied to the detection circuit 32 via the power receiving coil 311 connected to the matching circuit 312 at the resonant frequency.

By disposing the power feed position changer 214 and varying the power feed position in the power transmitting coil unit 21B in this manner, adjustment of the resonant frequency of the resonant coil and adjustment of the impedance of the resonant coil are enabled and the transmission efficiency can be enhanced.

### 4. Fourth Embodiment

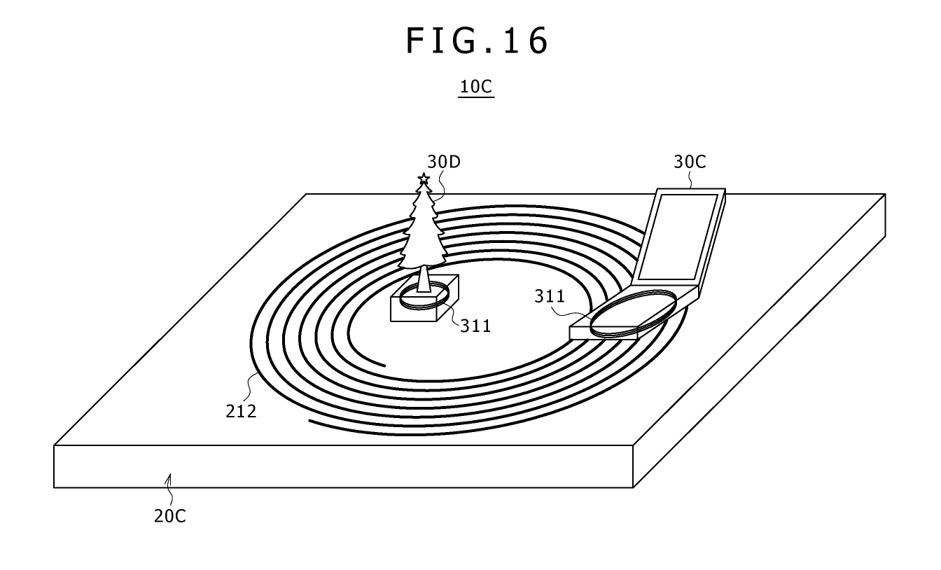

FIG. 16 is a diagram showing an application example of the wireless power feed system according to an embodiment of the present invention.

In this application example, a power feed device (power transmitting device) 20C is formed as a device that can be placed on a desk and the like and has e.g. a rectangular parallelepiped shape.

In FIG. 16, as examples of the power receiving device, the charger of small apparatus 30C such as a portable terminal and an electric illuminator 30D are shown.

The loop coil 311 for power reception is incorporated in the small apparatus 30C and the electric illuminator 30D.

To the charger of the small apparatus 30C and the electric illuminator 30D that are placed on the main surface 23 of the power feed device 20C or brought close to the power feed device 20C at a distance of several tens of millimeters, power is transmitted from the resonant coil 212 incorporated in the power feed device 20C, so that the transmitted power can be used for power feed to the charger of the small apparatus 30C, the electric illuminator 30D, and so forth.

This wireless power feed system 10C has high flexibility in position alignment similarly to the resonance type, and can simultaneously feed power to plural pieces of apparatus in parallel.

As described above, the wireless power feed systems of the embodiments of the present invention can achieve the following advantageous effects.

Specifically, according to the embodiments, the number of resonant coils may be one. Thus, the power receiving side can be configured by only a simple loop coil and a matching circuit and therefore size reduction of the power receiving side can be achieved.

The resonant frequency does not change even across a short distance. Thus, power feed with high efficiency is possible without a frequency adjustment circuit or the like and therefore the configuration is simplified.

Strict position alignment like that in the electromagnetic induction system is unnecessary, which gives high usability to the user.

Even in use with the combination with the power transmitting coil of a different resonant frequency, the power receiving side can be used by adjustment of the coupling strength dependent on the distance to the power receiving side and adjustment by the matching circuit.

The present application contains subject matter related to that disclosed in Japanese Priority Patent Application JP 2010-002187 filed in the Japan Patent Office on Jan. 7, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

1. A wireless power feed system comprising:
a power feed device; and
a power receiving device configured to receive power transmitted from the power feed device, wherein
the power feed device includes a power generator to generate power that should be fed, and a resonant element fed with power generated by the power generator, and
the power receiving device includes a power receiving element to receive power transmitted from the power feed device, and a matching unit including a function for impedance matching at a connecting part between the power and a load of the power receiving element.

2. The wireless power feed system according to claim 1, wherein
the power feed device includes the power generator to generate power that should be fed, and a power feed element that is fed with power generated by the power generator and is coupled to the resonant element by electromagnetic induction, and
the resonant element is coupled to the power feed element by electromagnetic induction.

3. The wireless power feed system according to claim 2, wherein
a matching unit including a function for impedance matching at a point of feed of power by the power generator to the power feed element is included.

4. The wireless power feed system according to claim 1, wherein
a power feed position changer to vary a position of feed of power by the power generator to the resonant element is included.

5. The wireless power feed system according to claim 1, wherein
frequency is determined by the resonant element, and
a transmission characteristic is capable of being adjusted by adjustment of coupling strength varying depending on distance between the resonant element on a power transmitting side and the power receiving element and impedance adjustment by the matching unit on a power receiving side.

6. A wireless power receiver, comprising:
a power receiving device element configured to receive power resonantly transmitted from a power feed device; and
a matching unit configured to match impedances of a load coupled to the wireless receiver and the power receiving device element,
wherein,
the receiver does not include a resonator to receive the resonantly transmitted power.
